(19) United States
(12) Patent Application Publication
(10) Pub. No.: US 2024/0102608 A1
(43) Pub. Date: Mar. 28, 2024

(54) FOOT PLATE

(71) Applicant: Tyson Nelson, Cedar City, UT (US)

(72) Inventor: Tyson Nelson, Cedar City, UT (US)

(21) Appl. No.: 18/461,412

(22) Filed: Sep. 5, 2023

Related U.S. Application Data
(60) Provisional application No. 63/403,859, filed on Sep. 5, 2022.

(51) Int. Cl. F16M 13/02; F16B 9/00

(52) U.S. Cl. CPC F16M 13/02; F16B 9/01; F16M 2200/08

(57) ABSTRACT

A foot plate, a foot plate and post assembly and method of using. The post has a first exterior side, a second exterior side, a third exterior side, a fourth exterior side, and a bottom edge. The foot plate has a top surface, a bottom surface and an opening having a first interior side corresponding to the first exterior side of a post, a second interior side corresponding to the second exterior side of the post, a third interior side corresponding to the third exterior side of the post, and a fourth interior side corresponding to the fourth exterior side of the post, wherein the opening fits around the post such that the foot plate is unable to rotate around the post but the bottom edge of the post can be aligned with the bottom surface of the foot plate. One or more connections secure the bottom surface of the foot plate to the bottom edge of the post. A weld secures the top surface of the foot plate to the post.

### RELATED APPLICATION

This application is related to U.S. Provisional Patent Application No. 63/403,859 for A Foot Plate, filed Sep. 5, 2022, which is hereby incorporated by reference for its supporting teachings.

### BACKGROUND

Foot plates are utilized in connection with a variety of top-mounted posts. Such posts, depicted at 200 in FIGS. 2-3, can provide foundational support for railing, fencing and other systems requiring a substantially vertical support structure. Foot plates provide stability to the post and allow for it to be anchored to a surface. Posts 200 are typically bolted to the top of a slab of concrete or wood surface and can be interconnected with one or more cross members 102. Often such posts support swinging gates—which, because of their substantial weight, need a bolt plate or “foot” on the bottom allowing lag bolts or other known securing mechanisms to secure the post to the concrete, and thereby support the gate with rigidity and strength to last for years to come. Posts 200 can be a variety of cross-sectional shapes including but not limited to substantially square, rectangular or other polygonal shapes as well as substantially circular, oval or other rounded shapes. All of the foregoing are deemed suitable for use with the present invention in its various embodiments.

As seen in FIGS. 1-3, one limitation with the prior art is the difficulty in proper placement of the foot plate 100 relative to the post 200 it supports. Specifically, in order for a foot plate to provide optimal stability to a post, it must be substantially centered and level. Using current foot plate solutions, a user must either just eyeball the positioning of the plate prior to securing it—typically with a weld or other strong bonding mechanism—utilizing a laborious trial and error exercise which is error-prone. Alternatively, current methodologies incorporate the use of jigs, measurements, and markings. In both cases, centering and leveling the foot plate is difficult to get right and failing to do so compromises the structural stability the foot plate is intended to provide. For example, an off-center foot plate does not provide as much lateral stability as a centered foot plate would. A foot plate that is not level can translate into an uneven post which, in addition to being aesthetically unappealing, adds a layer of difficulty in applying railings and other features to the posts because without a straight and plumb surface to mount to, finished product quality and integrity is diminished.

Another shortcoming of foot plates in the present state of the art is that they are prone to rusting. In particular, posts and associated structures such as railings are often hollow tubing and contain iron. Over time, water begins to accumulate inside the posts and railings through humidity and condensation. When a solid foot plate is affixed to the bottom of the tubing, it prevents such water from escaping. Rather, the water just pools at the bottom of the posts causing faster rusting and thereby decreasing the longevity of the post.

Equally problematic, in cold weather conditions, the water that accumulates can freeze and thus expand resulting in rupturing or fracturing of the tubing. The tubing has typically already been rusting from the water inside it. Upon freezing, the tubing expands with the ice and breaks, after this happens the rust continues at a rapid pace. Eventually, after the legs or posts are broken and rusted out, the railing needs to be fully replaced. Because the foot plate of the present invention in its various embodiments includes an opening, it allows water to drain from the tubing thus providing a significant advantage over the prior art.

Additionally, under the current state of the art, getting a good weld between the post and the foot plate can be problematic. The present device and methodology, with its largely self-centering and self-leveling feature, allows a user to apply one or more tack welds on a bottom surface of the foot plate that anchor the foot plate in place, leaving a clean and stable top surface on which a user can do a high quality, consistent weld line (rather than having periodic spot welds to weld over as would be required under the old methodology). This clean weld surface helps keep the weld largely free of contaminants or debris that could compromise its quality. Thus, the strength of the weld is improved thereby increasing the strength and longevity of the post and associated structure overall.

The present invention in its various embodiments addresses all of the foregoing issues as well as others as will be apparent in the present disclosure. Additionally, and not inconsequentially, the present device and methodology takes a fraction of the time to install compared to previously designed foot plates. The foot plate slides on the tube with a snug fit. Its self-centering and self-leveling feature means, once in place, the foot plate is already substantially squared with the leg or post. With a speed square the foot can be fully tacked on in under 30 seconds. This allows for a highly efficient process that is a significant improvement over the prior art and makes rapid production of railing systems feasible.

### SUMMARY

The present invention in its various embodiments is an improved foot plate. The foot plate includes a top surface, a bottom surface, and an opening. The opening corresponds to a post having a bottom edge. The foot plate opening fits around the post in a manner that the foot plate is unable to rotate around the post, but the bottom edge of the post can be aligned with the bottom surface of the foot plate, thus allowing for a self-centering and self-aligning feature.

In certain embodiments, the opening is substantially centered in the foot plate. However, different positioning of the opening is also considered to be within the scope of the present invention. In certain embodiments, the foot plate is substantially square in shape but different shapes of the foot plate including polygonal, rectangular and circular are considered to be within the scope of the present invention.

The foot plate can provide foundational support to posts in railings, fencing and other systems requiring a substantially vertical support structure. In certain embodiments, the post has a first exterior side, a second exterior side, a third exterior side, a fourth exterior side, and a bottom edge. The foot plate in such embodiments has a top surface, a bottom surface and an opening having a first interior side corresponding to the first exterior side of a post, a second interior side corresponding to the second exterior side of the post, a third interior side corresponding to the third exterior side of the post, and a fourth interior side corresponding to the fourth exterior side of the post. When assembled, one or more connections can secure the bottom surface of the foot plate to the bottom edge of the post and a weld can secure the top surface of the foot plate to the post.

In certain embodiments, the one or more connections securing the bottom surface of the foot plate to the bottom edge of the post are tack welds. In certain embodiments, the bottom edge of the post can be aligned with the bottom surface of the foot plate such that the bottom edge of the post is substantially flush with the bottom surface of the foot plate. In other embodiments, the bottom edge of the post is aligned with the bottom surface of the foot plate such that the bottom edge of the post is separated from the bottom surface of the foot plate by a substantially uniform distance. This distance can vary but in certain embodiments, it is between approximately 1/16 inches and 7/16 inches.

A method of securing a foot plate to a post is also provided for in the present invention in its various embodiments. A post is provided having a first exterior side, a second exterior side, a third exterior side, a fourth exterior side, and a bottom edge. A foot plate is also provided, wherein the foot plate has a top surface, a bottom surface and an opening having a first interior side corresponding to the first exterior side of a post, a second interior side corresponding to the second exterior side of the post, a third interior side corresponding to the third exterior side of the post, and a fourth interior side corresponding to the fourth exterior side of the post.

The post is inserted through the opening, with the opening fitting around the post such that the foot plate is unable to rotate around the post, but the bottom edge of the post can be aligned with the bottom surface of the foot plate. The bottom surface of the foot plate is secured to the bottom edge of the post with one or more connections. In certain embodiments, these connections are tack welds. The top surface of the foot plate is also secured to the post. In certain embodiments, this securing is made with one or more welds. In one embodiment, a single line weld is utilized.

The bottom edge of the post can be aligned with the bottom surface of the foot plate such that the bottom edge of the post is substantially flush with the bottom surface of the foot plate. As noted previously, in other embodiments, the bottom edge of the post can be aligned with the bottom surface of the foot plate such that the bottom edge of the post is separated from the bottom surface of the foot plate by a substantially uniform distance.

### BRIEF DESCRIPTION OF THE DRAWINGS

FIG. 1 is a depiction of foot plates attached to two posts connected by a cross member as found in the prior art.

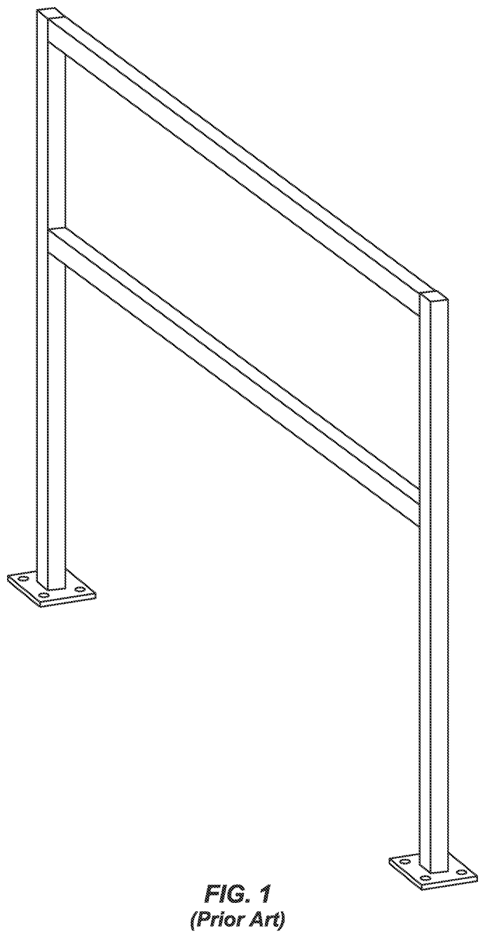

FIG. 2 is a topside view of a foot plate as found in the prior art.

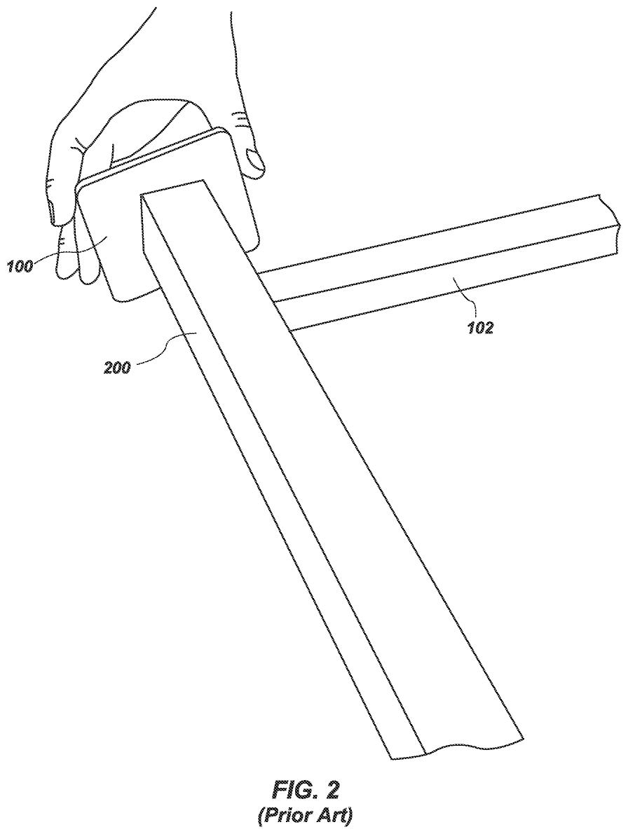

FIG. 3 is an underside view of a foot plate as found in the prior art.

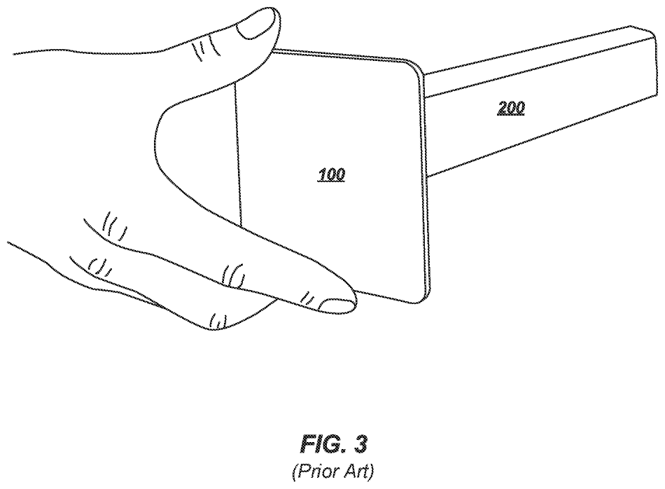

FIG. 4 is an improved foot plate according to one embodiment of the present invention.

FIG. 5 is an example of a typical post on which the present invention can be utilized.

FIG. 6 is an improved foot plate according to one embodiment of the present invention.

FIG. 7 is a topside view of the foot plate of FIG. 6, showing the improved positioning capabilities.

FIG. 8 is an underside view of the foot plate of FIG. 6, showing the improved positioning capabilities.

FIG. 9 depicts an underside of a foot plate according to one embodiment of the present invention utilizing a tack welding securing method.

FIG. 10 depicts an underside of a foot plate according to one embodiment of the present invention utilizing a tack welding securing method.

FIG. 11 depicts a topside view of a foot plate attached to a post according to one embodiment of the present invention.

FIG. 12 depicts a topside view of a foot plate attached to a post according to one embodiment of the present invention.

FIG. 13 depicts a pair of foot plates attached to posts according to one embodiment of the present invention.

FIG. 14 depicts variations of the present invention in its different embodiments.

### DESCRIPTION OF ILLUSTRATED EMBODIMENTS

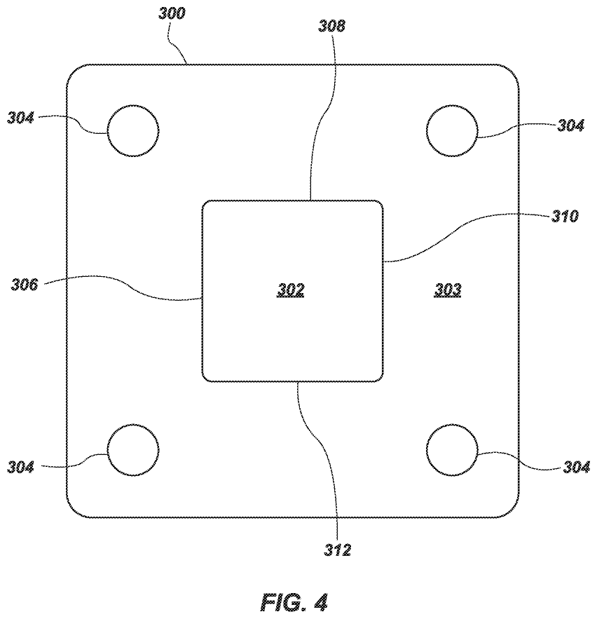

Referring to FIG. 4, an improved foot plate 300 is shown according to one embodiment of the present invention. In the present illustration, the top surface 303 of the foot plate 300 is shown. In subsequent drawings, the underside 301 of the foot plate 300 will be depicted.

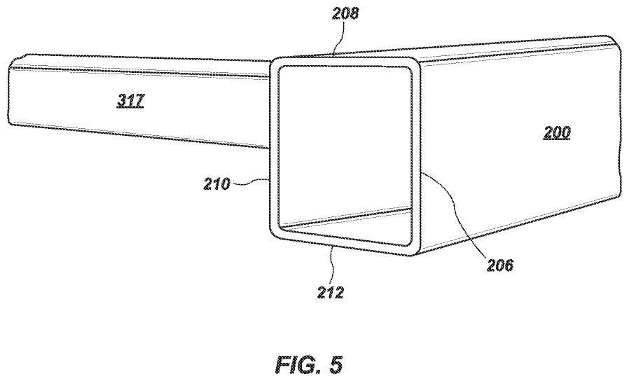

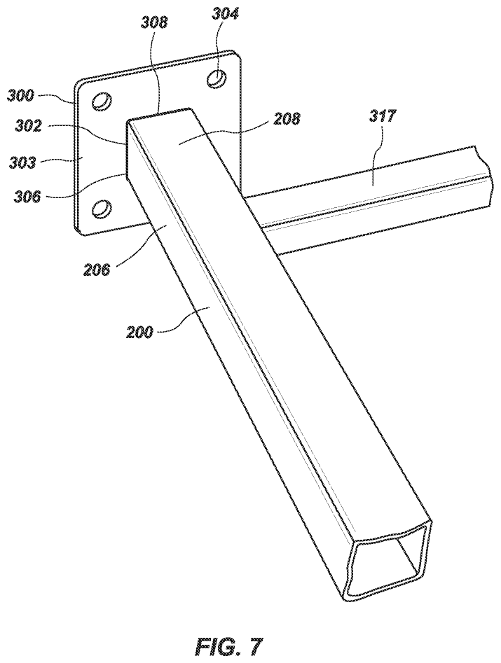

The foot plate 300 includes a center opening 302 corresponding to the outer edge of a post 200 (FIG. 5). In particular, the outside edge 206 of post 200 generally corresponds with the inside edge 306 of the center opening 302 of the foot plate 300. Similarly, the outside edge 208 of post 200 corresponds with the inside edge 308 of the center opening 302 of the foot plate 300. The outside edge 210 of post 200 corresponds with the inside edge 310 of the center opening 302 of the foot plate 300. The outside edge 212 of post 200 corresponds with the inside edge 312 of the center opening 302 of the foot plate 300. By lining up these respective edges, the center opening serves as a self-centering and self-leveling feature. Cross member 317 is also shown in FIGS. 5-7.

Foot plate 300 includes one or more peripheral openings 304 through which the foot plate is secured to a surface. These peripheral openings are peripheral in the sense that they are generally positioned on the outside of plate 300 relative to the central opening 302.

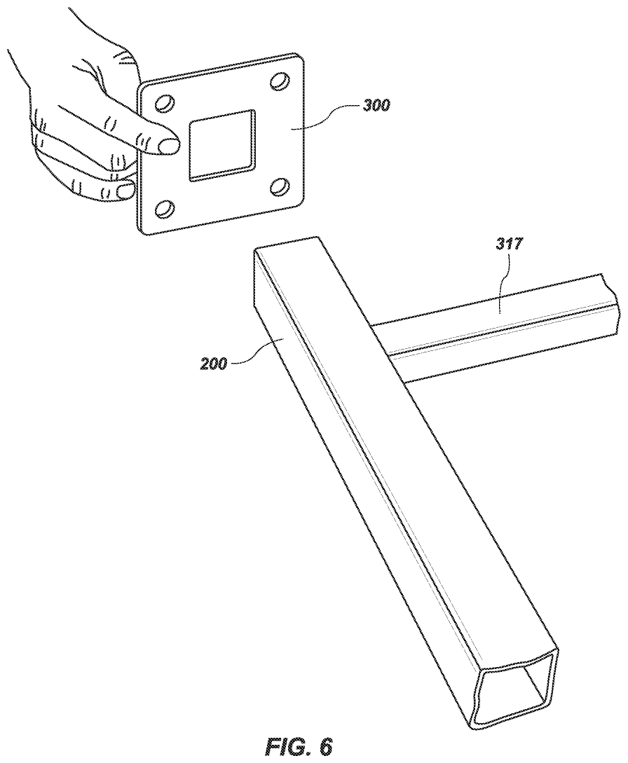

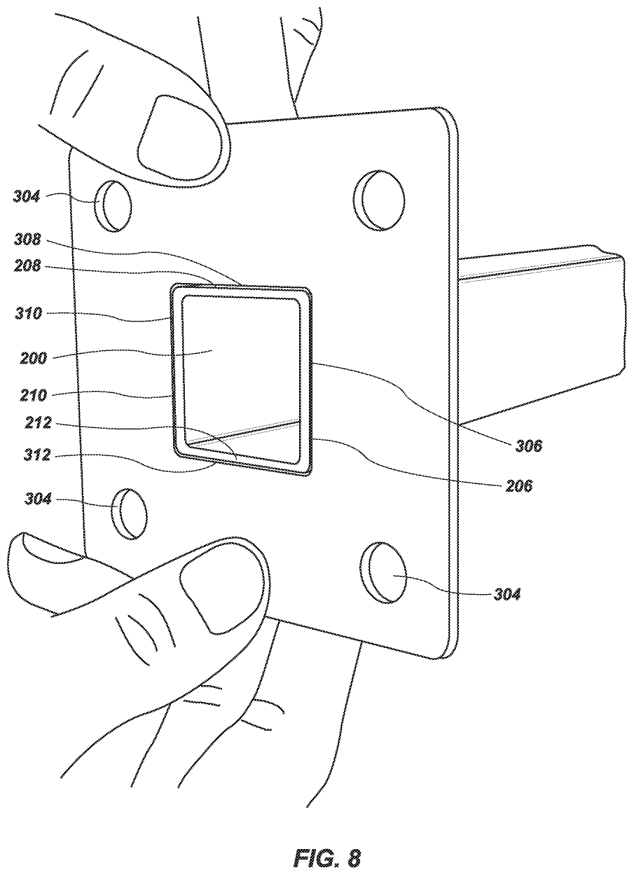

Referring to FIGS. 6-12, the self-centering and self-leveling feature of the present invention is depicted. Initially, the foot plate 300 is slid onto the post 200 by inserting the post 200 through the center opening 302 of the foot plate 300. Having center opening 302 slightly larger than, but conforming to, the outer surface of the post 200 allows a user to utilize edges in the center opening 302 to both center and level the foot plate 300. Specifically, and as discussed further below, the plate 300 slides on and, when it is flush with the bottom of post 200 or having a uniform bottom gap, a user knows it is substantially level. Because the center opening 302 matches up with the external shape of the post 200, a user can also know that the foot plate 300 is centered.

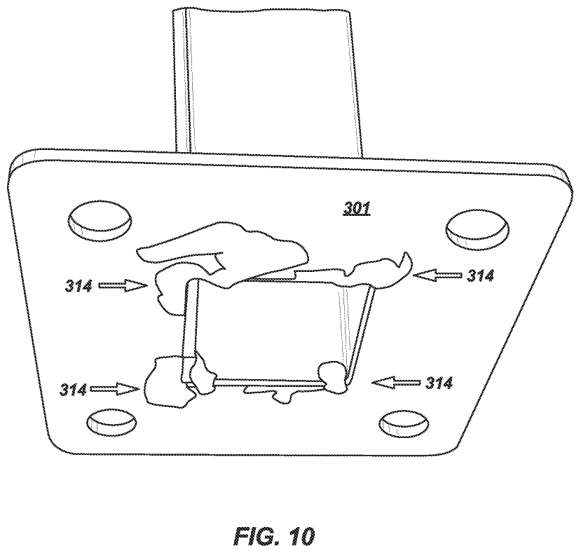

It is noted that, in certain embodiments, rather than having the plate 300 substantially flush with the bottom of the post 200, it may be desirable to instead place the foot plate 300 slightly lower than the bottom edge of the post 200 so the foot plate 300 can still sit flat on its desired surface as seen in FIG. 10. For example, if the post 200 is ⅛″ tubing, a bottom gap of roughly 1/16″ may be advantageous. In yet other embodiments, for example, if a ½″ plate 300 is being utilized, the bottom gap could be between approximately 1/16″ to approximately 7/16″. It depends on the preference and application of the plate 300.

Once centered and leveled, the plate 300 is initially secured with one or more spot or tack welds. While tack welds are well-suited for use with the present invention, in certain circumstances, other mechanisms may be utilized to initially secure the plate 300 to the post 200 before final welding. For example, depending on the post 200 and plate 300 materials, in certain embodiments plastic welding, adhesives and tapes may be used alone or in combination instead of a tack weld.

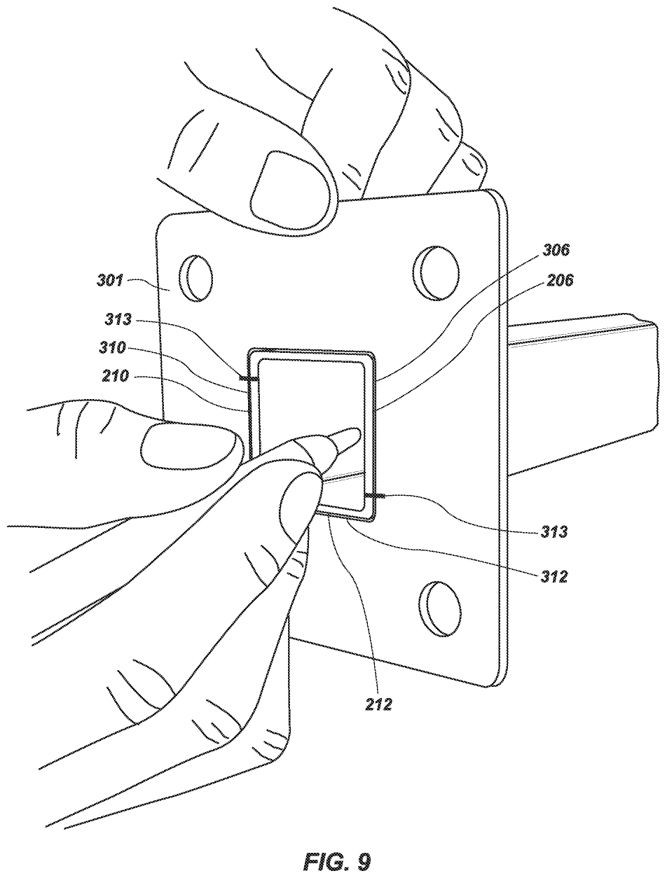

As seen in FIG. 9, markings 313 can be applied at the points (or substantially at the points) where tack welds can be utilized to initially anchor the foot plate 300 to the post 200. The number of tack welds need not be four but could vary depending on need and circumstances. The tack welds are also depicted as being approximately in the four corners of the post 200. However, other tack weld configurations could be utilized and are considered to be within the scope of the present invention.

The improved foot plates 300 are designed to fit just tight enough around the post 200 such that they do not allow for any rotational movement but remain loose enough to adjust the alignment of the plate on its X and Y axes in order to sure it up perfectly.

As each tack weld is applied, the user is able to sure up the foot plate 300 on the remaining unsecured sides. In so doing, the foot plate 300 is not only centered but also level. The foot plate 300 is also secured substantially flush with the bottom edge of the post 200. This process allows the foot plate 300 to be affixed level, plumb and square (i.e., properly positioned along all three axes). As noted above, this method significantly improves production time.

FIG. 10 depicts the underside 301 of a foot plate 300 according to one embodiment of the present invention. Also depicted are the tack welds 314 that have been applied roughly at the marks 313 (not shown).

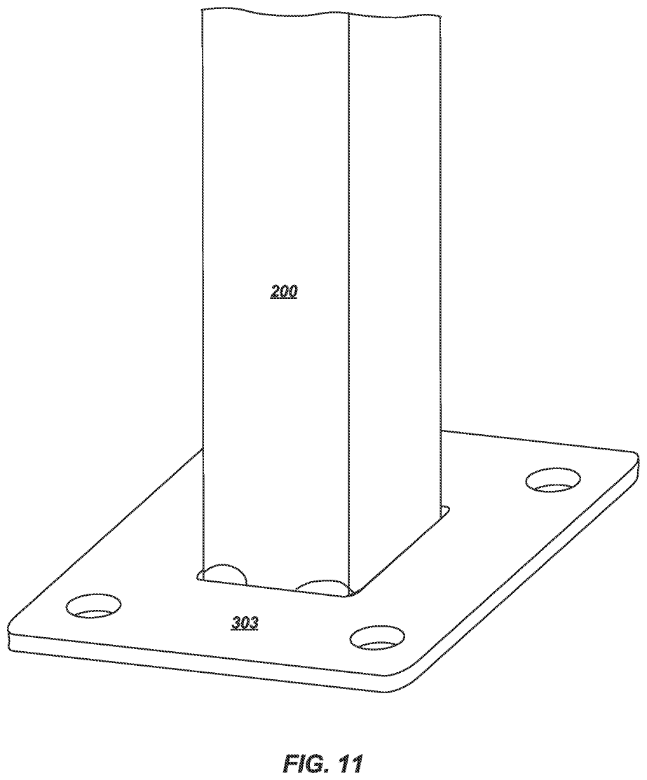

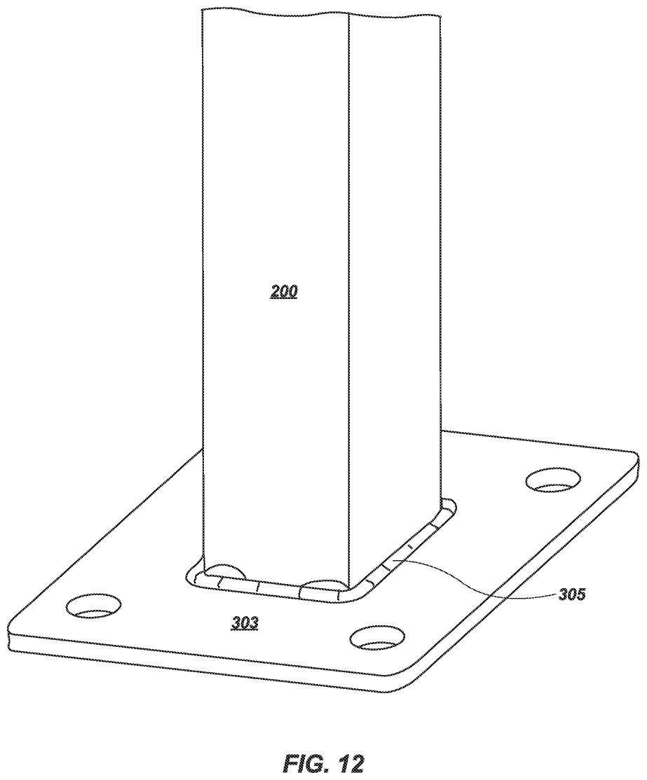

Referring now to FIGS. 11 and 12, an additional advantage of the present device and methodology is illustrated. Specifically, under the current state of the art, getting a good weld between the post 200 and the foot plate 300 can be problematic. The present device and methodology, with its largely self-centering and self-leveling feature, allows a user to apply one or more tack welds 314 on a bottom surface 301 of the foot plate 300 (see FIG. 11) that anchor the foot plate in place, leaving a clean and stable top surface 303 on which a user can do a high quality, consistent weld line 305 (rather than having periodic spot welds as would be required under the old methodology) as seen in FIG. 12. This clean weld surface helps keep the weld largely free of contaminants or debris that could compromise its quality. Thus, the strength of the weld is improved, thereby increasing the overall strength and longevity of the post and associated structure. It is also noted that for thicker plates, it may be advantageous to weld both sides of the plate 300. In other words, a weld can be applied at both the top surface 303 and the bottom surface 301 of the plate 300.

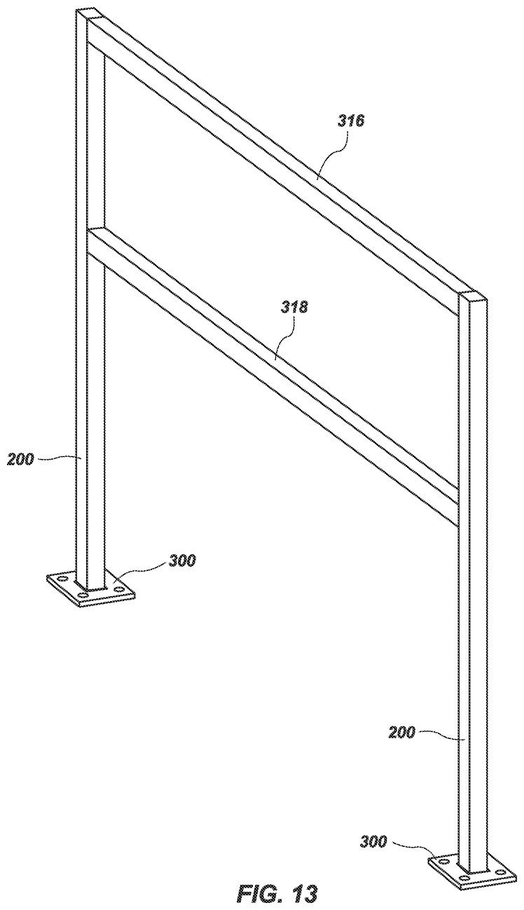

FIG. 13 depicts a foot plate 300 attached to a post 200 according to one embodiment of the present invention. Top rail 316 and middle rail 318 are also shown to illustrate one application of the present invention in the context of a railing system.

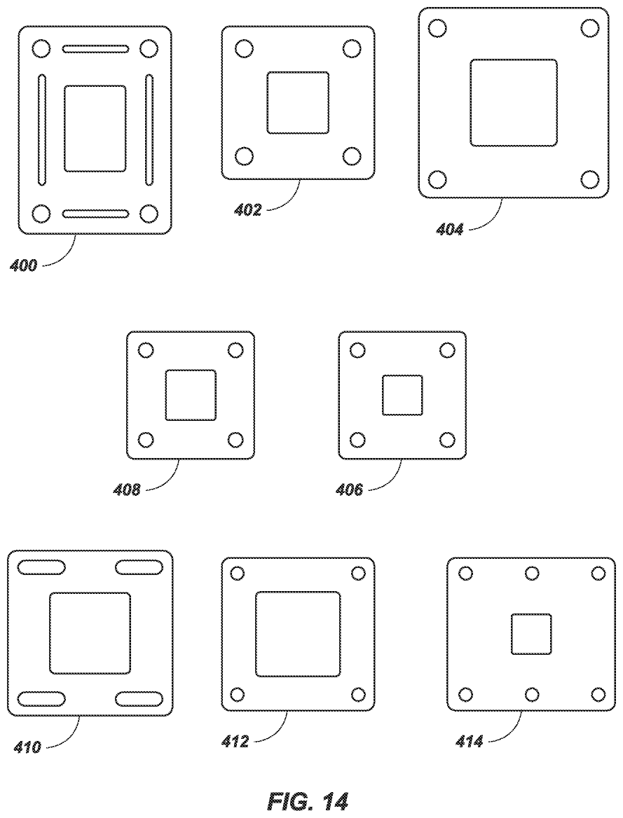

FIG. 14 depicts variations of the present invention in its different embodiments. As can be seen, the present invention can be adapted to a variety of post sizes and shapes as well as utilize a variety of mechanisms to secure the foot plate 300 to an underlying surface. In certain embodiments 400, the peripheral openings 304 through which the plate 300 is secured to an underlying surface could be slots or rounded openings through which bolts or screws are inserted. Other peripheral opening 304 shapes could also be utilized alone or in combination accommodating vast numbers of securing mechanisms as would be apparent to one skilled in the art. Embodiment 400 also includes a more rectangular center opening corresponding to the outer edge of post tubing. Embodiments 402, 404, 406, 408, 410, 412 and 414 depict different sized center openings corresponding to the outer edges of post tubing. Embodiment 410 utilizes slotted peripheral openings. Embodiment 414 utilizes six peripheral openings in contrast to the four openings in other embodiments (e.g., embodiment 412).

In certain embodiments, the foot plate 300 is substantially square in shape—which allows for equal distribution of support in all directions. However, in other embodiments, it may be advantageous to have the foot plate 300 substantially circular in shape. Foot plates 300 could also be other shapes including, but not limited to rectangular, triangular or other polygonal shapes depending on need and circumstances.

The various embodiments are shown to illustrate that the present invention in its various embodiments contemplates a variety of foot plate sizes and shapes; a variety of center openings corresponding to a variety of post tubing sizes and shapes; and a variety of peripheral openings that can accommodate a wide variety of securing mechanisms known in the art to secure the foot plate to a surface.

Materials. The foot plate 300 is generally constructed from steel but could be other materials alone or in combination including but not limited to any metallic material including but not limited to aluminum, steel, stainless steel, titanium, copper, brass and bronze. In certain embodiments, the plate could also be made in whole or in part of plastic or wood.

The foot plates 300 are generally used with posts 200 comprising steel tubing. However, the present invention in its various embodiments could also be utilized with other substantially vertical posts. These posts could be made of numerous materials alone or in combination including but not limited to any metallic material including but not limited to aluminum, steel, stainless steel, titanium, copper, brass and bronze. In certain embodiments, the post 200 could also be made in whole or in part of plastic or wood.

The posts shown in the illustrated embodiments are substantially square in cross-section. However, posts of numerous other cross-sectional shapes, alone or in combination, could be utilized including, but not limited to substantially round, substantially triangular, or other polygonal shapes.

In one embodiment, 1″ square tubing is used for the post. In yet other embodiments, 10″ square tubing is used. For any thickness or size of post or tubing the concept is the same.

Illustrative Method.

In an effort to assist in understanding the present invention, but without intending to limit the scope of the present invention, the following illustrative model is provided. A user would place a 3″ square tube post on a welding table. The bottom 12″ of the post is hanging off the edge of the table, but the post is securely clamped to the table. The length and dimensions of the post could vary depending on need and circumstances. The foot plate is square with outside dimensions of 6″×6.″ The foot plate has four ½″ holes placed near each corner to accommodate lag bolts to be screwed into the concrete slab and secure the bolt plate to the concrete or wood surface depending on circumstances. Wood is very common to mount to inside homes and buildings; metal surfaces can be bolted to as well, both giving the post the strength it needs.

The foot plate includes a square cut out of its center that measures roughly 3.072″×3.072″ that is designed to fit directly over the base of the post, without being too tight to fit over the bottom edge, or too loose to twist side to side (Z axis) when in place.

The outside edges of the foot plate are in line with the outside edges of the square tubing. With that, a user is ready to attach the foot to the post. In the illustrated embodiment, this involves the user adjusting the placement of the foot so that it sits approximately 1/16″ below the furthest bottom edge of the tubing, so the foot can sit flat on its desired surface. However, as noted above, in other embodiments, it may be desirable to have foot substantially flush with bottom edge of the tubing. For purposes of illustration only, the corners of the foot plate are assigned the following numbers: Top left=Corner #1; Top right=Corner #2; Bottom Right=Corner #3; and Bottom left=Corner #4.

In the illustrated embodiment, a user aligns the foot plate 1/16″ below the bottom edge of the tubing and “tack welds” the #1 corner of the foot to the tubing. Next the user will use a speed square to align the foot. This is done by placing the speed square on the tubing vertically (tubing laying horizontally with the end 12″ off of the Top worktable) and sliding the speed square alignment edge down to corner #1 (where the user just tacked it). In this illustration, the Y axis is adjusted first. With the speed square alignment edge touching the horizontal edge of the tube, and the top face of the foot plate, a user can adjust the angle of the bolt plate to match the alignment of the speed square (e.g., this can be done with use the user's hand or a small hammer). Once it is aligned with the speed square, the user would make a second tack on Corner #4 to keep the foot plate in alignment with the speed square. The speed square is removed and laid horizontally on the top face of the tubing, with the short alignment edge of the speed square covering Corner #1, and the direction of the speed square running towards corner #2.

The speed square is then slid until it touches the top face of the bolt plate again. The top edge of the foot plate is then aligned to match the alignment of the speed square. Once aligned, Corner #2 is tacked to hold the foot plate in alignment with the speed square. The speed square is removed, and Corner #3 is tacked and the centering, leveling and anchoring process are complete. With that, the foot plate is aligned on the X, Y, and Z axis in respect to the direction of the post, and it is ready to be finish welded.

This technique for installing each foot plate works for sloped feet as well. If, for example, a user is mounting surface slopes 3*X, the user would simply use an angled alignment tool and position the foot to the correct orientation. Similarly, the present invention can also work on a diagonal slope (e.g., 3*X and 4*Y).

Certain embodiments of the present invention can be utilized on 40+ degree sloped railing feet to maintain a plumb post on a sloped mounting surface. This design and concept can be used for any size tubing, pipe, or item on which a user wishes to weld a bolt plate to, regardless of thickness or outside dimensions. It can be used on any mounting slope, or a level slope and allow for a slanted post if needed. As long as the hole is calculated correctly to accommodate for the mounting edge of the tubing or post.

Production of the Foot Plates According to One Embodiment.

The outside dimensions of the desired post tubing are measured. By way of illustration, if a foot plate for a 3″×3″ piece of square tubing is wanted, a center opening of 3.072″×3.072″ square is produced. This production can occur utilizing a variety of methods. In certain circumstances, CAD software is utilized. The center opening is placed substantially in the center of the foot plate. This opening can be created with a plasma or laser cutting tool.

It is understood that the above-described arrangements are only illustrative of the application of the basic principles of the present invention. Numerous modifications and alternative arrangements may be devised by those skilled in the art without departing from the spirit and scope of the present invention. The appended claims are intended to cover such modifications and arrangements.

What is claimed is:

1) A foot plate and post assembly comprising:
a post having a first exterior side, a second exterior side, a third exterior side, a fourth exterior side, and a bottom edge;
a foot plate having a top surface, a bottom surface and an opening having a first interior side corresponding to the first exterior side of a post, a second interior side corresponding to the second exterior side of the post, a third interior side corresponding to the third exterior side of the post, and a fourth interior side corresponding to the fourth exterior side of the post, wherein the opening fits around the post such that the foot plate is unable to rotate around the post but the bottom edge of the post can be aligned with the bottom surface of the foot plate;
one or more connections securing the bottom surface of the foot plate to the bottom edge of the post;
a weld securing the top surface of the foot plate to the post.

2) The foot plate and post assembly of claim 1, wherein the one or more connections securing the bottom surface of the foot plate to the bottom edge of the post are tack welds.

3) The foot plate and post assembly of claim 1, wherein the bottom edge of the post is aligned with the bottom surface of the foot plate such that the bottom edge of the post is substantially flush with the bottom surface of the foot plate.

4) The foot plate and post assembly of claim 1, wherein the bottom edge of the post is aligned with the bottom surface of the foot plate such that the bottom edge of the post is separated from the bottom surface of the foot plate by a substantially uniform distance.

5) The foot plate and post assembly of claim 4, wherein the substantially uniform distance is between approximately 1/16 inches and 7/16 inches.

6) The foot plate and post assembly of claim 1, wherein the opening is substantially centered in the foot plate.

7) A foot plate comprising:
a top surface;
a bottom surface; and
an opening corresponding to a post having a bottom edge, wherein the opening fits around the post such that the foot plate is unable to rotate around the post, but the bottom edge of the post can be aligned with the bottom surface of the foot plate.

8) The foot plate of claim 7, wherein the opening is substantially centered in the foot plate.

9) The foot plate of claim 7, wherein the opening is substantially polygonal.

10) The foot plate of claim 7, wherein the opening is substantially rectangular.

11) The foot plate of claim 7 further comprising one or more peripheral openings.

12) A method of securing a foot plate to a post comprising the steps of:
providing the post, wherein the post has a first exterior side, a second exterior side, a third exterior side, a fourth exterior side, and a bottom edge;
providing the foot plate, wherein the foot plate has a top surface, a bottom surface and an opening having a first interior side corresponding to the first exterior side of a post, a second interior side corresponding to the second exterior side of the post, a third interior side corresponding to the third exterior side of the post, and a fourth interior side corresponding to the fourth exterior side of the post;
inserting the post through the opening, wherein the opening fits around the post such that the foot plate is unable to rotate around the post, but the bottom edge of the post can be aligned with the bottom surface of the foot plate;
securing the bottom surface of the foot plate to the bottom edge of the post with one or more connections;
securing the top surface of the foot plate to the post with a weld.

13) The method of claim 12, wherein the one or more connections securing the bottom surface of the foot plate to the bottom edge of the post are tack welds.

14) The method of claim 12, wherein the bottom edge of the post is aligned with the bottom surface of the foot plate such that the bottom edge of the post is substantially flush with the bottom surface of the foot plate.

15) The method of claim 12, wherein the bottom edge of the post is aligned with the bottom surface of the foot plate such that the bottom edge of the post is separated from the bottom surface of the foot plate by a substantially uniform distance.

16) The method of claim 15, wherein the substantially uniform distance is between approximately 1/16″ and 7/16″.

17) The method of claim 12, wherein the opening is substantially centered in the foot plate.

18) The method of claim 12, further comprising the step of applying one or more markings on the bottom surface of the foot plate prior to securing the bottom surface of the foot plate to the bottom edge of the post with one or more connections.

19) The method of claim 12, wherein the foot plate is substantially square in shape.

20) The method of claim 12, wherein the foot plate is substantially circular in shape.
